(19) United States
(12) Patent Application Publication
(10) Pub. No.: US 2024/0346177 A1
(43) Pub. Date: Oct. 17, 2024

(54) Personal Data Protection

(71) Applicant: LiveRamp, Inc., San Francisco, CA (US)

(72) Inventors: James Q. Arnold, Tiburon, CA (US); Shreyas Kumar, San Francisco, CA (US)

(21) Appl. No.: 18/701,336

(22) PCT Filed: Oct. 18, 2022
(86) PCT No.: PCT/US2022/047034

§ 371 Date: Apr. 15, 2024

Related U.S. Application Data
(60) Provisional application No. 63/270,117, filed on Oct. 21, 2021.

(51) Int. Cl. G06F 21/62

(52) U.S. Cl. CPC G06F 21/6245

(57) ABSTRACT

A system to protect personal data privacy, while allowing future processing of the data with methods not known when the personal data are received, creates references to the individual data items, which can be used to specify combinations of processing and representation using the original personal data as input to the specified processing. Raw personal data is extracted and inserted into a secure database, and primary keys are assigned to the personal data for retrieval. A personal data repository is maintained in a high-security zone. The system further includes a service providing retrieval of processed personal data, and a parsed records file that contain attributes and personal data keys.

### BACKGROUND

In a data privacy environment, data controllers are those parties that control the purposes and means by which personal data is processed in a digital environment. Data processors are those parties that process personal data on behalf of a data controller. Personal data means any information relating to an identified or identifiable natural person. An identifiable natural person is one who can be identified, directly or indirectly, in particular by reference to an identifier such as a name, an identification number, location data, an online identifier or to one or more factors specific to the physical, physiological, genetic, mental, economic, cultural or social identity of that natural person. Data controllers can use personal data to customize website activity, to tailor content for a given individual, to select advertisements based on personal preferences, and to perform many other useful functions. To protect the privacy of the individuals to whom this data pertains, however, all personal data must be kept secure and released only to authorized recipients.

In nearly all cases, applicable privacy laws and regulations require that the original (i.e., raw) personal data must be held only by the original data controller or data processor and only for valid business purposes, in order to protect privacy. Thus to use the personal data for customization purposes, the raw personal data must be altered, generating pseudonymous data that cannot be related back to the original data subject (i.e., the person) associated with the personal data. Pseudonymous data is defined as data that no longer allows the identification of a data subject associated with the personal data without additional information that is kept separate from the pseudonymous data. This is different from anonymous data, which is data processed such that it removes all possibility of reversibly identifying the data subject, regardless of the existence of any additional information that may be combined with the data.

Various measures are used to process personal data, including without limitation normalization, encryption, and cryptographic hashing. These processes have numerous variations, producing pseudonymous data to be exchanged between data controllers, data processors, websites, advertisers, and other entities. As an example of normalization, consider the email address “John. O'Shea@mail.com”. Depending on the data processing, the normalized email address might be “johnoshea@mail.com”, “john.oshea@mail.com”, “john.o'shea@mail.com”, or other variations. The normalized email address is then further processed, such as being encrypted or cryptographically hashed. Encryption and hashing also have variants, using different encryption keys, hashing/encryption techniques, and encryption salts, for example. The final value of such processing is considered pseudonymous and can be exchanged for customization purposes without a loss of privacy.

As can be seen from this example, different pseudonymization methods are possible. If the data is normalized by one method to create pseudonymized data and the original data discarded, then the data processor cannot process a request to use data that would have been normalized differently during pseudonymization. A data processor may find it advantageous to retain its data in a form such that it will be usable regardless of the method of normalization that is applied, whether that is an existing technique or one that may be introduced in the future. This would increase the flexibility of the data processor's processing, while still protecting the privacy of the associated data. The data processor thus may face the following simultaneous problems: (1) how to retain personal data in a way that minimizes the chance of unauthorized disclosure; (2) how to support pseudonymization methods that might be introduced in the future that are different from the current methods; and (3) how to generate files that can be processed under regular computing environments and that support “privacy by design” principles. What is desired then is a way to protect the privacy of personal data, while also allowing future processing of the data with methods not known when the personal data are received.

References mentioned in this background section are not admitted to be prior art with respect to the present invention.

### SUMMARY

The present invention is directed to a system and method to protect the privacy of personal data, while allowing future processing of the data with methods not known when the personal data are received. The personal data can be securely stored, preventing unauthorized disclosure of the data. This is accomplished by creating references to the individual data items, which can be used to specify combinations of processing and representation using the original personal data as input to the specified processing. In various embodiments, the system and method may include a process to extract raw personal data and insert the data into a secure database; a process to assign primary keys to the personal data for retrieval; a personal data repository maintained in a high-security zone with business policies and personnel access restrictions to prevent visibility of personal data; a service providing retrieval of processed (e.g., normalized, encrypted, and/or hashed) personal data; and a parsed records file that contain attributes and personal data keys.

These and other features, objects and advantages of the present invention will become better understood from a consideration of the following detailed description in conjunction with the drawings as described following:

### DRAWINGS

FIG. 1 is a diagram of a personal data workflow according to an embodiment of the present invention.

FIG. 2 is an architectural diagram of hardware to implement a personal data workflow according to an embodiment of the present invention.

FIG. 3 is a diagram of a detail of the data flow for the translation zone according to an embodiment of the present invention.

FIG. 4 is an architectural diagram of hardware to implement a data flow for the translation zone according to an embodiment of the present invention.

### DETAILED DESCRIPTION OF CERTAIN EMBODIMENTS

Before the present invention is described in further detail, it should be understood that the invention is not limited to the particular embodiments described, and that the terms used in describing the particular embodiments are for the purpose of describing those particular embodiments only, and are not intended to be limiting, since the scope of the present invention will be limited only by the claims.

The processes and methods of certain embodiments of the invention as described herein make use of three data storage zones. These zones may be implemented as physically or logically separate, on individual local storage media or across one or more cloud storage media. The zones are referred to herein as the general zone, the private zone, and the translation zone. The general zone applies general security and is company private, but is generally visible to developers at the provider. No personal data is placed into the general zone. The private zone also applies general security and is company private, but access is limited to company technical services and a subset of developers with a need to know. The private zone is used for accepting and processing customer files, including personal data. Files are transient in this zone, and all personal data are deleted as soon as the files finish ingestion processing. Finally, the translation zone is the highest security zone, restricted by policy to a small set of trained company personnel. The network providing access to the translation zone is restricted to authorized traffic only, with no external access allowed. The translation zone contains highly sensitive data such as encryption keys.

Company business policies for data security may include minimizing access to the data. In implementations of the present invention, specific organizations within the provider company are designated to maintain the systems that house personal data such that people and organizations without a need to access the systems are denied access. Moreover, people in the designated organizations are given special training on data security, and those people are legally bound to protect the confidentiality of data under their control.

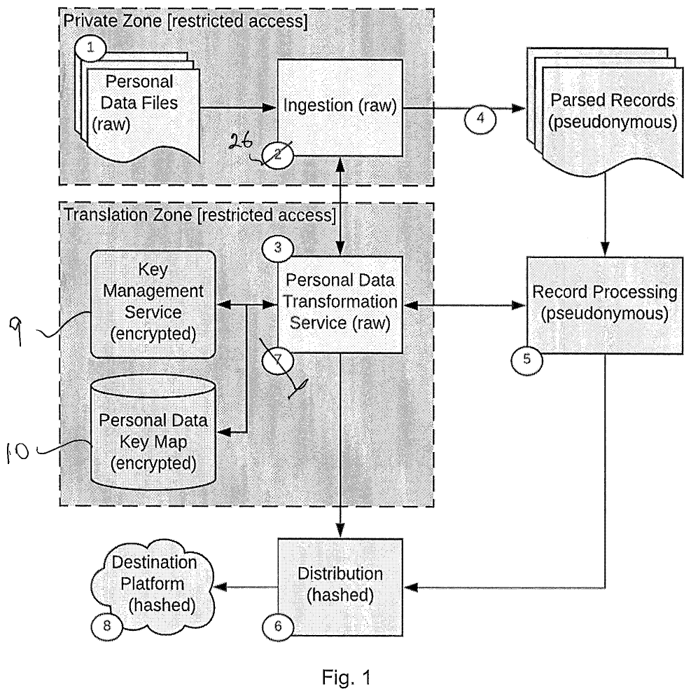

With reference to the description of zones just provided, a general personal data workflow overview according to an embodiment of the present invention may be described with reference to FIG. 1. At step 1, external data controllers create files containing records with raw personal data. These files are made available in the private zone.

At ingestion compute engine step 26, the ingestion process monitors arrival of these raw personal data files 1 and processes them. Ingestion engine 26 examines each record of the raw personal data input, identifies specific personal data items, and passes them to the personal data transformation service 3.

Next, the personal data transformation service 3 takes raw personal data as input. It then creates a personal data key for each item using key management service 9. When the personal data key is created, personal data transformation service 3 then stores the key, the personal data, and associated metadata in the personal data key map 10. Personal data key map 10 is an encrypted database. The personal data keys are returned to the ingestion engine 26.

Next, ingestion engine 26 receives the personal data keys and replaces the original raw items with the personal data keys. It then creates parsed records 4. When ingestion finishes, all personal data has been removed from the original input. The parsed records 4 are stored for subsequent processing.

During subsequent processing, beginning with record processing step 5, the record processing module reads parsed records including the personal data keys therein. It contacts the personal data transformation service 3 to retrieve the encrypted, hashed, normalized personal data, and uses these new values to replace the personal data keys in the parsed records 4.

Next, distribution processing 6 performs one last translation on the parsed records 4. Each item of encrypted, hashed personal data is encrypted with a key specific to the destination platform. The “same” data being sent to different destinations will therefore differ, making it impossible for two destinations to correlate the encrypted, hashed personal data items.

Returning to personal data transformation service step 3, the service performs the encryption referenced immediately above. It first decrypts the encrypted, hashed personal data items using a standard key. It then uses the key management service 9 to retrieve an encryption key specific to the destination platform. This destination-specific key is used to encrypt the data item.

Finally, at destination platform step 8, the updated parsed records are transmitted to the destination platform.

Personal data keys are implemented in certain embodiments with the following properties. These properties will be assigned letters for further reference below.

Property A of the personal data keys is that each personal data key should allow unique association with an item of personal data. The personal data transformation service does not expose raw personal data, but it does provide access to encrypted, hashed, normalized personal data. Personal data keys are the values that a client presents for a request. Thus a personal data key should uniquely map to an individual personal datum.

Property B of the personal data keys is that the personal data keys should be implemented in such a way that parsed records should protect personal identities. Parsed records are maintained in the relatively low security general zone. Although they are protected from exposure to the public, they are visible to people inside the provider company. That makes the files vulnerable to theft or exposure by a bad actor inside the company. Thus if a parsed record file is sent outside the company (against company policy), the personal data keys should not allow associating specific records with individual people.

Property C of the personal data keys is that they should be implemented in a manner to prevent systematic probes of the personal data key map. This protection addresses two issues. First, it will, given a known individual, prevent retrieving map data for that individual. Also, it will, given data retrieved from the map, prevent identifying the individual associated with the data. Access to the personal data key map is limited to authorized users, and the map is protected inside the relatively secure translation zone. If, however, a bad actor wanted to exploit its access, personal data keys should thwart efforts to associate data with individuals.

Property D of the personal data keys is that they should support any new normalization, hashing, and encryption methods, allowing existing parsed records to be processed with the new methods.

Personal data keys are generated in the high-security translation zone. Components in the translation zone also manage encrypted personal data and provide normalization and cryptographic hashing. In overview, creation of personal data keys may proceed in the following steps. First, a raw personal datum is presented for encoding, such as “A. Smith.” A new universally unique identifier (UUID) is generated for the datum. UUIDs are typically 128-bit labels used for information in computer systems. UUIDs may be created in multiple ways, including but not limited to creation by concatenation of a MAC address with a timestamp; hashing of a namespace identifier; and random generation. Because of the large universe of potential UUIDs in any given identity space, they are, for practical purposes, unique. An example UUID for “A. Smith” could be “8399d898-b826-11eb-8529-0242ac130003.” Once the UUID is created, it is then cryptographically salted. As is well known in cryptography, a salt is random or pseudo-random data that is used as an additional input to a one-way function, such as one that hashes data. A salted UUID in this case could be “8399d898-b826-11eb-8529-0242ac130003+334573c16f9c2006.” The salted UUID is then hashed, yielding the personal key. Using the SHA-256 hashing technique in one particular non-limiting example, a personal key in this case could be “ad3aa2cdabe4781e44950d7077c1f006828167b84e9f8a08a1705749437138ad.” As noted above, the personal data key replaces the original personal data, transforming the raw personal data files into the parsed records.

The personal keys generated in this manner fulfill each of the properties described above. As already noted, the process starts with a personal data item, such as the name “A. Smith.” Leaving this value in a parsed record would allow direct association of the record's data with an individual, thereby defeating privacy. Using the raw personal data as the key would fail property B as described above.

Each UUID is a 128-bit value, representing about 3.4*10³⁸ possibilities. Given a world population (2021) of about 7.9 billion (7.9*10⁹), a UUID offers plenty of capacity to uniquely identify personal data. There is no explicit link between the UUID and the personal data, so the UUID passes properties A and B noted above. On the other hand, UUIDs can be generated in a predictable way, such as the following sequence:

3c153032-b8c9-11eb-8529-0242ac130003
3c1532e4-b8c9-11eb-8529-0242ac130003
3c153654-b8c9-11eb-8529-0242ac130003
3c153730-b8c9-11eb-8529-0242ac130003

The similarity of these values could allow an adversary to predict a range of UUIDs, if the UUIDs were used as keys. This might, in turn, allow a systematic probe of the personal data key map using predicted key values. A bad actor potentially could use such probes to defeat privacy, and thus the UUIDs of this nature would fail property C.

Applying a cryptographic salt adds randomness to the UUID. In particular, 64 bits are added in the example above. If both the UUID and the salt appear in the actual key, the salted UUID has the same characteristics as the raw UUID. That is, if the bad actor can determine the salt, the salt does not enhance security. Thus the raw salted UUID satisfies properties A and B but fails property C.

Cryptographically hashing the salted UUID distributes those values over a larger key space. In the example above, the salted UUID creates a unique, random 192-bit value (approximate 6.3*10⁵⁷ possibilities). Using SHA-256, for example, the raw salted UUIDs are distributed into a 256-bit digest space (approximate range of 1.2*10⁷⁷). Given any personal data input mapped to a salted UUID, the SHA-256 digest generates a unique key for the data. Thus property A is satisfied. Parsed records would contain the SHA-256 digests in place of personal data. Even if the SHA-256 digest could be reversed (which is impossible under current technology), the underlying value is a salted UUID, disconnected from the original personal data. Thus the parsed records themselves cannot be used to derive personal data, satisfying property B.

The examination of whether the personal data keys meet property C may be divided into two parts. First, in what may be considered property “C.a,” given personal data for a known individual, could that be used to find associated data? For example, suppose a bad actor was in possession of the name of A. Smith and wanted to find other related information. That would require deriving the personal data key (ad3a . . . 38ad) from the known data (“A. Smith”). The process to create the original key generated a UUID and a random salt. Both of these values are extremely difficult to reproduce. Even if the creation time of the UUID could be narrowed to one second in time, the bad actor would have 163 billion possibilities to consider. Determination of the 64-bit random salt is even more difficult. Using secure random number generation, a 64-bit value gives 1.8*10¹⁹ possibilities to consider. Taken together, the bad actor would have 2.8*10³⁰ potential salted UUIDs to consider. To put this number in context, the Earth's age is estimated at 4.5 billion years, or 1.4*10¹⁷ seconds. Thus the bad actor would have to evaluate roughly 10 trillion items per second, since the creation of the Earth, to check all of the possibilities.

Alternatively, the bad actor could try probing the SHA-256 digest values directly, such as through a rainbow table. This approach would not be feasible either, as salts are an effective counter to rainbow table attacks. The raw UUID+salt has 6.3*10⁵⁷ possibilities. These values are distributed into 1.2*10⁷⁷ SHA-256 digest possibilities, giving approximately 1 valid digest for every 1.9*10¹⁹ possibilities. Even more to the point, actual personal data would be limited to perhaps 1012 possibilities, not 1057. Actual personal data keys thus would occupy approximately 1 of every 1065 entries in the total SHA-256 digest space. Thus personal data keys satisfy property C.a.

With what will be termed property C.b. herein, one may approach the issue from the opposite direction. That is, given encrypted, hashed, normalized personal data retrieved from the personal data key map, the goal is to prevent the association of that data with a known individual. This attempt could use two approaches. One is to attack the encrypted, hashed, normalized personal data directly. With current technology, it is impossible to decrypt and reverse the hash of the encoded data. Another approach is to associate the encrypted, hashed, normalized personal data with a known person, using the personal data key as the weakness. This problem resolves to the same issue as C.a., which was discussed above. Thus personal data keys satisfy property C.b.

With respect to property D, the personal data transformation service provides all normalization, hashing, and encryption for its clients. Importantly, the creation of personal data keys can be done completely independently from normalization, hashing, and encryption. Consequently, a parsed record file can be created first, and subsequently the personal data transformation service could be augmented with new normalization, hashing, or encryption methods. The record processing module or the distribution module could use the old parsed records as input and request the new normalization, hashing, or encryption methods. Thus personal data keys satisfy property D.

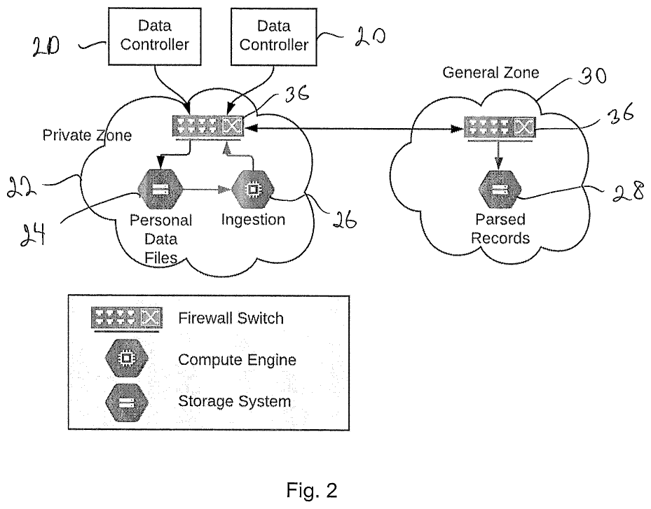

Referring now to FIG. 2, a hardware architecture for implementation of the system to perform these processes may be described. External data controllers 20 transfer personal files into the secure private zone 22. Data Controllers 22 are operated by external entities (e.g., companies) that run their own computing environment. They are granted specific networking permissions to pass data through the network firewall 36 into the private zone 22. These permissions take the form of network configuration plus login and password for account access. The network configuration controls electronic access, allowing traffic from a data controller 20 and blocking network traffic from unknown sources. The login and password further check the data controller 20, giving a second level of protection from unauthorized access. Only authorized users would have a valid login and password combination. Each data controller 20 places personal data files 24 with raw personal data into the physical storage devices of the private zone 22. These are presented to ingestion compute engine 26.

The ingestion compute engine 26 runs on compute engine hardware within the private zone 22. This ingestion compute engine 26 reads the raw personal data files 24, processes each record, replaces raw personal data items with personal data keys, and transfers these parsed records to physical storage devices of parsed records storage system 28 in the general zone 30. When ingestion compute engine 26 finishes processing a personal data file, and the parsed records have been generated, the personal data file 24 is removed. At that point, all instances of raw personal data are eliminated within the domain of the data processor 20.

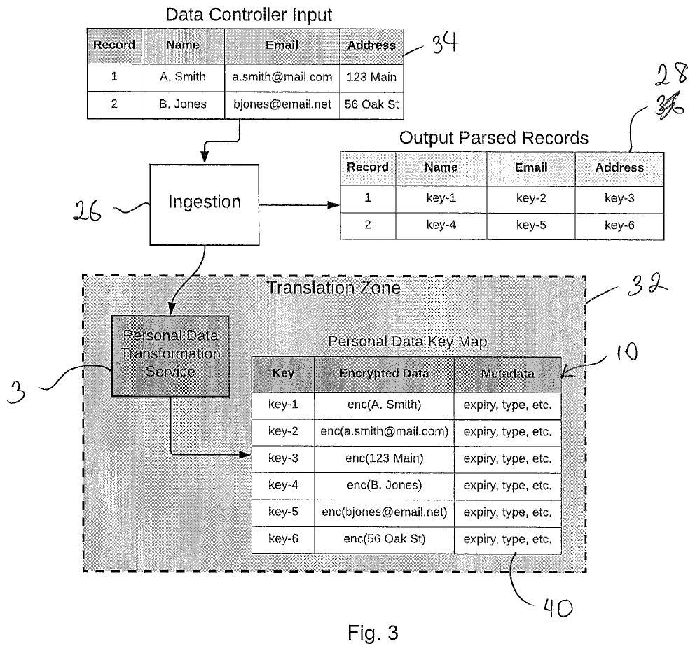

FIG. 3 provides a further example of the steps in a process using a system as described above with a focus on the translation zone 32. Two records are received from the data controller in this case, containing personal information related to persons “A. Smith” and “B. Jones.” This information is shown in data controller input 34. The information in the records further includes an email address and postal address for each person. At ingestion compute engine 26, the output parsed records 28 contain personal data keys for each of these six individual data points. In the translation zone 32, the personal data transformation service 3 associates the keys stored in the output parsed records with encrypted data and metadata in the personal data key map 10.

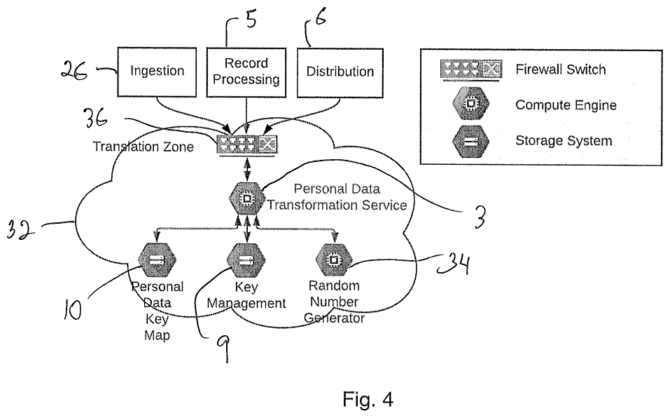

A hardware architecture to implement the translation zone 32 may be described with reference to FIG. 4. Ingestion 26, record processing 5, and distribution 6 rely on functionality from the high-security translation zone 32. They are granted specific networking permissions to pass data through the network firewall 36 into the translation zone 32. In certain embodiments, they cannot access translation zone 32 hardware resources directly. That is, they do not have direct access to the personal data key map 10, to the key management 9, nor to the random number generator 34. Moreover, the translation zone 32 is protected by multiple levels of security. Physical security controls access to the real-world facilities. In other words, unauthorized persons are denied physical entry to the data center premises. The network configuration controls electronic access, allowing traffic from known clients and blocking network traffic from unknown sources. In this instance, all three clients (ingestion 26, record processing 5, and distribution 6) are controlled by the owner of the translation zone 32. Although they operate outside the translation zone 32, unknown clients are denied access to the personal data transformation service 3. All personnel with access to the translation zone 32 are given special security training. Business policies and practices limit access to the translation zone 32.

The personal data key map 10 and the key management system 9 occupy specialized, encrypted storage devices to protect the associated data. Even if the physical devices were stolen (or accessed outside security policy) by a bad actor, the raw personal data and the raw encryption keys would not be exposed to the bad actor.

The personal data transformation service 3 runs on compute engine hardware within the translation zone 32. This component prevents access to the raw personal data and provides specific services to clients. First, it provides the service of, given a personal datum, creating a personal data key. This includes generation of personal data keys, encrypting the raw personal data, and adding the new key and the encrypted data to the personal data key map 10. Second, it provides the service of, given a personal data key, computing an encrypted, hashed, normalized value for the associated personal datum. Third, it provides the service of, given a datum encrypted with one key, return the same datum encrypted with another key. That is, translate an encrypted, hashed, normalized datum from one key space to another.

Random salt values play a critical role in the generation of personal data keys. Specialized hardware, the random number generator 34, provides random data used for the cryptographic salts. As with other components of the translation zone, the random number generator 34 cannot be accessed from outside the translation zone 32.

In certain data privacy implementations, there may be goals of “data minimization” and data retention limitations (either express or implied). In other words, a data controller or data processor might want to collect personal data, keep it for a specific period based on business needs, and then automatically discard that data. FIG. 3 shows a metadata column 40 associated with each record in the personal data key map 10. The metadata could include, in certain non-limiting examples, an expiry value. Depending on the details of the storage hardware and the personal data key map 10, this expiry could be enforced through hardware or software. Either way, entries in the personal data key map 10 could be deleted without human intervention, ensuring data retention limits are respected.

An alternative embodiment of the invention as described above is private envelopes in parsed records. This alternative puts encrypted personal data in a parsed record file. Private envelopes could have the following structure:
[protocol_id] [initialization_vector] [encrypted_payload]
   The “encrypted_payload” ciphertext can be passed to a service in the translation zone 32 to be decrypted and then processed into encrypted, hashed, normalized personal data. The underlying data could be interpreted as raw personal data, or perhaps an anonymous identifier. Either way, both types of the raw payload are generally considered personal data for present purposes.

In the private envelope approach, and given parsed records to process, a workflow would call the personal data transformation service 3 in the secure translation zone 32. The service would receive encrypted personal data, decrypt it, apply the selected operations, generate hashed personal data for the downstream platform, and return the hashed personal data to the caller. All encryption and decryption operations happen in the secure translation zone 32. Encryption keys exist only in the translation zone 32, managed by a secure key management service 9, possibly using key rotation. The new parsed records expose singly encrypted personal data. (This could optionally be doubly encrypted to further improve security.) The new records make it possible to recover the raw personal data for flexible normalization and subsequent hashing/encryption.

An advantage of the private envelope approach is that new normalization, hashing, and encryption requirements could be supported by updating the personal data transformation service 3. All files previously ingested under this alternative could be used for new destinations, because the personal data transformation service 3 could recover the original, raw personal data. A customer could request delivery to a new platform without having to resend files that had been previously ingested. Furthermore, a customer would not need to declare in advance what destination platforms the customer planned to use.

Another advantage of the private envelope approach is that it uses a single representation of each personal data item in a parsed record file. No duplication of the “same” data with different encodings would occur.

A potential drawback of the private envelope approach is that it inserts encrypted personal data directly into parsed records. Those parsed record files are, according to certain embodiments of the present invention, stored in the general zone 30. Despite the difficulty of breaking modern encryption, having the data directly accessible is a potential concern.

Another potential drawback of the private envelope approach is that encrypted personal data is still considered personal data under certain standards, meaning parsed records in this alternative may be geographically restricted by applicable laws or regulations. This would mean all parsed record processing must happen in a particular geographic location. That is, onboarding, workflows, and distribution would have to occur in the same geographic area.

Still another potential drawback of the private envelope approach is that putting encrypted personal data directly in parsed records may also conflict with customer expectations. The principles of “privacy by design” and “data minimization” influence data providers' commercial decisions, and direct use of encrypted personal data might have negative consequences as a result.

Another alternative embodiment of the present invention would use pre-computed encrypted, hashed personal data in parsed records. This alternative reuses the basic parsed record framework, but it inserts duplicate values for hashed personal data fields. Given a set of normalization rules and hashing techniques, ingestion would apply all the normalization and all the hashing, generating multiple hashed values for each personal data input value. All the “duplicate” values would be added to the parsed record files.

For purposes of normalization, there would be multiple rules to apply, with distinct rules for different types of personal data. For example, an email address might undergo the following hypothetical normalizations:

```
  J.O'Shea@mail.com → joshea@mail.com (lowercase, no dots, no
punctuation)
  J.O'Shea@mail.com → j.oshea@mail.com (lowercase, no punctuation)
  J.O'Shea@mail.com → JOShea@mail.com (retain case, no dots, no
punctuation)
  J.O'Shea@mail.com → j.o'shea@mail.com (lowercase only)
```

Hashing options may include the SHA-1, SHA-256, and MD5 techniques as non-limiting examples. Thus in this example, a single email address in the input file might create 4*3=12 hashed email values in the parsed records (i.e., four normalizations, each hashed three ways).

An advantage of this pre-compute approach is that it uses the existing security and data ethics framework. It also extends the current parsed record format, with minimal disruption to existing onboarding components. Finally, the resulting hashed personal data in the parsed records can be used directly to prepare the distribution file 6. It may still be desirable, however, for the personal data transformation service 3 to manage normalization, hashing, and encryption operations in the translation zone 32.

A potential drawback of the pre-compute approach is that it cannot use old parsed records when new operations are added. That is, if a new destination requires a new normalization operation, the data in existing parsed records could not be used. The original, raw personal data are not available, and the new normalized hash values cannot be created from existing data. The same issue applies when working through integration issues. If the exchange with a distribution platform does not work, and the provider needs to revise its normalization and hashing, the input data must be redelivered and reprocessed.

Another potential drawback of the pre-compute approach is that parsed record storage expands with the duplicate hashed personal data values added. This could be reduced, however, at the cost of limiting future use for additional downstream platforms.

Still another potential drawback of the pre-compute approach is that the audience store expands with the duplicate hashed personal data values (audience stores are managed by data access). Currently hashed personal data are treated as anonymous identifiers, and a parsed record file's anonymous identifiers are retained in the audience store. This is potentially more significant than parsed record storage, because the audience store is retained indefinitely. Moreover, increasing the audience store size adds read/write overhead for the associated processing, incurred with each use of the store.

Still another potential drawback of the pre-compute approach is that it does not support processing in certain jurisdictions with more strict privacy laws or regulations.

Still another potential drawback of the pre-compute approach is that when the provider prepares parsed records with duplicate hashed values for distribution, it would need to omit the irrelevant values from the distribution file for a specific platform. For example, when sending data to Company A, all the non-Company A hashed personal data would need to be dropped.

Still another potential drawback of the pre-compute approach is that hashed personal data objects would need to characterize the internal values: type of personal data, normalization applied, and hash technique used. The objects according to certain embodiments of the present invention have implicit normalization rules. The object definitions would need to specify normalization operations explicitly.

The systems and methods described herein may in various embodiments be implemented by any combination of hardware and software. For example, in one embodiment, the systems and methods may be implemented by a computer system or a collection of computer systems, each of which includes one or more processors executing program instructions stored on a computer-readable storage medium coupled to the processors. The program instructions may implement the functionality described herein. The various systems and methods as illustrated in the figures and described herein represent example implementations. The order of steps in the methods may be changed, and various elements may be added, modified, or omitted to the systems.

A computing system or computing device as described herein may be implemented using a hardware portion of a cloud computing system or non-cloud computing system. The computer system may be any of various types of devices, including, but not limited to, a commodity server, personal computer system, desktop computer, laptop or notebook computer, mainframe computer system, handheld computer, workstation, network computer, a consumer device, application server, storage device, mobile telephone, or in general any type of computing node or device. The computing system includes one or more processors (any of which may include multiple processing cores, which may be single or multi-threaded) coupled to a system memory via an input/output (I/O) interface. The computer system further may include a network interface coupled to the I/O interface.

In various embodiments, the computer system may be a single processor system including one processor, or a multiprocessor system including multiple processors. The processors may be any suitable processors capable of executing computing instructions. For example, in various embodiments, they may be general-purpose or embedded processors implementing any of a variety of instruction set architectures. In multiprocessor systems, each of the processors may commonly, but not necessarily, implement the same instruction set. The computer system also includes one or more network communication devices (e.g., a network interface) for communicating with other systems and/or components over a communications network, such as a local area network, wide area network, or the Internet. For example, a client application executing on the computing device may use a network interface to communicate with a server application executing on a single server or on a cluster of servers that implement one or more of the components of the systems described herein in a cloud computing or non-cloud computing environment as implemented in various sub-systems. In another example, an instance of a server application executing on a computer system may use a network interface to communicate with other instances of an application that may be implemented on other computer systems.

The computing device also includes one or more persistent storage devices and/or one or more I/O devices. In various embodiments, the persistent storage devices may correspond to disk drives, tape drives, solid state memory, other mass storage devices, or any other persistent storage devices. The computer system (or a distributed application or operating system operating thereon) may store instructions and/or data in persistent storage devices, as desired, and may retrieve the stored instruction and/or data as needed. For example, in some embodiments, the persistent storage may include the solid-state drives attached to that server node. Multiple computer systems may share the same persistent storage devices or may share a pool of persistent storage devices, with the devices in the pool representing the same or different storage technologies.

The computer system includes one or more system memories that may store code/instructions and data accessible by the processor(s). The system memories may include multiple levels of memory and memory caches in a system designed to swap information in memories based on access speed, for example. The interleaving and swapping may extend to persistent storage in a virtual memory implementation. The technologies used to implement the memories may include, by way of example, static random-access memory (RAM), dynamic RAM, read-only memory (ROM), non-volatile memory, or flash-type memory. As with persistent storage, multiple computer systems may share the same system memories or may share a pool of system memories. System memory or memories may contain program instructions that are executable by the processor(s) to implement the routines described herein. In various embodiments, program instructions may be encoded in binary, Assembly language, any interpreted language such as Java, compiled languages such as C/C++, or in any combination thereof; the particular languages given here are only examples. In some embodiments, program instructions may implement multiple separate clients, server nodes, and/or other components.

In some implementations, program instructions may include instructions executable to implement an operating system, which may be any of various operating systems, such as UNIX, LINUX, MacOS™, or Microsoft Windows™ Any or all of program instructions may be provided as a computer program product, or software, that may include a non-transitory computer-readable storage medium having stored thereon instructions, which may be used to program a computer system (or other electronic devices) to perform a process according to various implementations. A non-transitory computer-readable storage medium may include any mechanism for storing information in a form (e.g., software) readable by a machine (e.g., a computer). Generally speaking, a non-transitory computer-accessible medium may include computer-readable storage media or memory media such as magnetic or optical media, e.g., disk or DVD/CD-ROM coupled to the computer system via the I/O interface. A non-transitory computer-readable storage medium may also include any volatile or non-volatile media such as RAM or ROM that may be included in some embodiments of the computer system as system memory or another type of memory. In other implementations, program instructions may be communicated using optical, acoustical or other form of propagated signal (e.g., carrier waves, infrared signals, digital signals, etc.) conveyed via a communication medium such as a network and/or a wired or wireless link, such as may be implemented via a network interface. A network interface may be used to interface with other devices, which may include other computer systems or any type of external electronic device. In general, system memory, persistent storage, and/or remote storage accessible on other devices through a network may store data blocks, replicas of data blocks, metadata associated with data blocks and/or their state, database configuration information, and/or any other information usable in implementing the routines described herein.

In certain implementations, the I/O interface may coordinate I/O traffic between processors, system memory, and any peripheral devices in the system, including through a network interface or other peripheral interfaces. In some embodiments, the I/O interface may perform any necessary protocol, timing or other data transformations to convert data signals from one component (e.g., system memory) into a format suitable for use by another component (e.g., processors). In some embodiments, the I/O interface may include support for devices attached through various types of peripheral buses, such as a variant of the Peripheral Component Interconnect (PCI) bus standard or the Universal Serial Bus (USB) standard, for example. Also, in some embodiments, some or all of the functionality of the I/O interface, such as an interface to system memory, may be incorporated directly into the processor(s).

A network interface may allow data to be exchanged between a computer system and other devices attached to a network, such as other computer systems (which may implement one or more storage system server nodes, primary nodes, read-only node nodes, and/or clients of the database systems described herein), for example. In addition, the I/O interface may allow communication between the computer system and various I/O devices and/or remote storage. Input/output devices may, in some embodiments, include one or more display terminals, keyboards, keypads, touchpads, scanning devices, voice or optical recognition devices, or any other devices suitable for entering or retrieving data by one or more computer systems. These may connect directly to a particular computer system or generally connect to multiple computer systems in a cloud computing environment or other system involving multiple computer systems. Multiple input/output devices may be present in communication with the computer system or may be distributed on various nodes of a distributed system that includes the computer system. The user interfaces described herein may be visible to a user using various types of display screen technologies. In some implementations, the inputs may be received through the displays using touchscreen technologies, and in other implementations the inputs may be received through a keyboard, mouse, touchpad, or other input technologies, or any combination of these technologies.

In some embodiments, similar input/output devices may be separate from the computer system and may interact with one or more nodes of a distributed system that includes the computer system through a wired or wireless connection, such as over a network interface. The network interface may commonly support one or more wireless networking protocols (e.g., Wi-Fi/IEEE 802.11, or another wireless networking standard). The network interface may support communication via any suitable wired or wireless general data networks, such as other types of Ethernet networks, for example. Additionally, the network interface may support communication via telecommunications/telephony networks such as analog voice networks or digital fiber communications networks, via storage area networks such as Fibre Channel storage area networks (SANs), or via any other suitable type of network and/or protocol.

Any of the distributed system embodiments described herein, or any of their components, may be implemented as one or more network-based services in the cloud computing environment. For example, a read-write node and/or read-only nodes within the database tier of a database system may present database services and/or other types of data storage services that employ the distributed storage systems described herein to clients as network-based services. In some embodiments, a network-based service may be implemented by a software and/or hardware system designed to support interoperable machine-to-machine interaction over a network. A web service may have an interface described in a machine-processable format, such as the Web Services Description Language (WSDL). Other systems may interact with the network-based service in a manner prescribed by the description of the network-based service's interface. For example, the network-based service may define various operations that other systems may invoke, and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP). In some embodiments, network-based services may be implemented using Representational State Transfer (REST) techniques rather than message-based techniques. For example, a network-based service implemented according to a REST technique may be invoked through parameters included within an HTTP method such as PUT, GET, or DELETE.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. When a grouping is used herein, all individual members of the group and all combinations and sub-combinations possible of the group are intended to be individually included in the disclosure. When a range is stated herein, all sub-ranges within the range and all distinct points within the range are intended to be individually included in the disclosure. All references cited herein are hereby incorporated by reference to the extent that there is no inconsistency with the disclosure of this specification.

The present invention has been described with reference to certain preferred and alternative embodiments that are intended to be exemplary only and not limiting to the full scope of the present invention, as set forth in the appended claims.

1. A system for protecting the privacy of personal data, the system comprising:
a private zone implemented on one or more first storage devices in communication with the one or more processors, the one or more storage devices having stored thereon a plurality of personal data files comprising records of raw data and a set of instructions that, when executed by the one or more processors, cause the one or more processors to identify specific data items within the set of raw data;
a translation zone implemented on one or more second storage devices in communication the one or more processors, the translation zone comprising a personal data key map comprising a mapping between each of the specific data items and a corresponding personal data key for each of the specific data items, and a set of instructions that, when executed by the one or more processors, cause the one or more processors to replace each of the specific data items with the corresponding personal data key;
a general zone implemented on one or more third storage devices, wherein the general zone comprises a set of parsed records wherein the specific data items within the records of raw data are replaced by the corresponding personal data keys; and
a personal data key creation subroutine configured to execute on the one or more processors to cause the one or more processors to:
receive a specific data item;
generate a unique identifier corresponding to the specific data item;
generate either a random or pseudo-random salt;
concatenate the unique identifier with the salt to produce a salted unique identifier; and
hash the salted unique identifier to produce the personal data key corresponding to the original specific data item.

2. The system of claim 1, wherein the private zone comprises a private zone security protocol configured to provide access only to persons with a need to know.

3. The system of claim 2, wherein the translation zone comprises a translation zone security protocol configured to provide access only to designated persons.

4. The system of claim 3, wherein the general zone comprises a general zone security protocol configured to allow access to developers.

5. A system for personal data protection, the system comprising:
one or more processors;
one or more storage devices in communication with the one or more processors, wherein the storage devices comprise a set of instructions that, when executed by the one or more processors, cause the one or more processors to:
receive, from at least one data controller, a plurality of data records;
identify specific data items in the set of data records;
create a personal data key for each of the specific data items by generating a unique identifier corresponding to each of the specific data items, generating either a random or pseudo-random salt for each unique identifier,
concatenating each unique identifier with the salt to produce a salted unique identifier, and hashing each salted unique identifier to produce the personal data key corresponding to each of the specific data items;
store the specific data items, a set of corresponding personal data keys, and a set of associated metadata in a personal data key map within a restricted access zone on the one or more storage devices; and
replace the specific data items with the corresponding personal data keys to create a set of parsed records comprising the personal data keys.

6. A personal data workflow method, comprising:
receiving, from at least one data controller, a set of raw personal data in a private zone;
ingesting the set of raw personal data to identify specific data items within the set of raw personal data;
creating a personal data key for each of the specific data items within the set of raw personal data by generating a unique identifier for each of the specific data items, generating either a random or pseudo-random salt for each unique identifier, concatenating each unique identifier with the salt to produce a salted unique identifier, and hashing each salted unique identifier to produce the personal data key corresponding to each of the specific data items;
for each of the specific data items within the set of raw personal data, storing the specific data item, its corresponding personal data key, and a set of associated metadata in a personal data key map within a translation zone;
replacing the specific data items with the corresponding personal data keys and sending the personal data keys back to the private zone; and
creating a set of parsed records comprising the personal data keys corresponding to the specific data items.

7. The method of claim 6, further comprising the step of reading the set of parsed records and transferring at least one of the parsed records in the set of parsed records to a personal data transformation service.

8. The method of claim 7, wherein the personal data transformation service replaces personal data in the at least one parsed record.

9. The method of claim 7, further comprising the step of performing a second hash using a second hash key that is specific to a destination platform.

10. The method of claim 9, further comprising the step of sending the parsed record to the destination platform corresponding to the second hash key.

11. The method of claim 10, further comprising the step of storing the second hash key corresponding to each of a plurality of destination platforms.

12. A method for producing a personal data key corresponding to a specific data item, the method comprising the steps of:
receiving one of the specific data items at a processor;
producing a unique identifier corresponding to the specific data item;
generating at the processor either a random or pseudo-random salt;
concatenating the unique identifier with the salt at the processor to produce a salted unique identifier; and
hashing at the processor to hash the salted unique identifier to produce the personal data key corresponding to the specific data item.

13. The method of claim 12, wherein the unique identifier comprises a universally unique identifier (UUID).

14. The method of claim 13, wherein the hashing step is performed using a SHA-256 hash algorithm.

15. A personal data key engine, comprising:
one or more processors; and
a non-transitory computer-readable medium storing instructions that, when executed by the one or more processors, cause the one or more processors to:
receive a specific data item;
generate a unique identifier corresponding to the specific data item;
generate a pseudo-random salt;
concatenate the unique identifier with the salt to produce a salted unique identifier; and
hash the salted unique identifier to produce the personal data key corresponding to the original specific data item.

16. The personal data key engine of claim 15, wherein the unique identifier comprises a universally unique identifier (UUID).

17. The personal data key engine of claim 16, wherein the instructions further comprise a SHA-256 hash coding to hash the salted unique identifier.
